(19) United States
(12) Patent Application Publication
(10) Pub. No.: US 2011/0083649 A1
(43) Pub. Date: Apr. 14, 2011

(54) CONTROL DEVICE FOR INTERNAL COMBUSTION ENGINE

(75) Inventor: Shigeki Miyashita, Susono-shi (JP)

(73) Assignee: TOYOTA JIDOSHA KABUSHIKI KAISHA, Toyota-shi (JP)

(21) Appl. No.: 12/999,944

(22) PCT Filed: Apr. 17, 2009
(86) PCT No.: PCT/JP2009/057756

§ 371 Date: Dec. 17, 2010

(51) Int. Cl. F02M 25/07

(52) U.S. Cl. 123/568.19

(57) ABSTRACT

In an internal combustion engine which can switch the number of cylinders in operation between the total number of cylinders and some of the cylinders, an EGR rate at a time of a transitional operation can be kept correct at a time of any of a full cylinder operation and a partial cylinder operation. A throttle is operated to an opening degree corresponding to an accelerator operating amount and the number of cylinders in operation so that outputs with respective to the accelerator operating amount become equal at the time of the full cylinder operation and at the time of the partial cylinder operation. When the opening degree of the throttle is changed due to change in the accelerator operating amount, the opening degree of the EGR valve is changed at a relatively high speed at the time of the full cylinder operation, and the opening degree of the EGR valve is changed at a relatively low speed at the time of the partial cylinder operation. The opening degree of the EGR valve is preferably changed at a speed corresponding to a change speed of pressure in a surge tank.

### TECHNICAL FIELD

The present invention relates to a control device for an internal combustion engine, and particularly relates to a control device for an internal combustion engine which includes an EGR system, and can switch the number of cylinders in operation between the total number of cylinders and some of the cylinders.

### BACKGROUND ART

An EGR system which recirculates part of an exhaust gas to an intake system is known. The EGR system is configured by an EGR passage which connects an exhaust passage and an intake passage, and an EGR valve which is provided in the EGR passage. The amount of an EGR gas which is recirculated to the intake system (hereinafter, the EGR amount) can be regulated by the opening degree of the EGR valve. With regard to the internal combustion engines including such EGR systems, various control techniques have been proposed as disclosed in, for example, Japanese Patent Laid-Open No. 7-332165, Japanese Patent Laid-Open No. 2007-309298, or Japanese Patent Laid-Open No. 2004-27971.

Further, an internal combustion engine which can switch the number of cylinders in operation between the total number of cylinders and some of the cylinders is known. As disclosed in Japanese Patent Laid-Open No. 2004-27971 cited above, an EGR system can be loaded on such an internal combustion engine.

In the internal combustion engine including an EGR system, at the time of a transitional operation in which a load changes, change of the opening degree of the EGR valve is performed in combination with change of the opening degree of the throttle. The amount of the EGR gas which is recirculated to the intake system is determined by the negative pressure of the surge tank and the opening degree of the EGR valve, and this is because if the opening degree of the throttle changes, the negative pressure of the surge tank also changes. By changing the opening degree of the EGR valve in accordance with a load change, the amount of the EGR gas which is recirculated to the intake system can be controlled, and the target EGR rate can be kept even at the time of a transitional operation.

Changing the opening degree of the EGR valve in accordance with a load change like this can be similarly performed in the internal combustion engine which can switch the number of cylinders in operation. However, even under the same load, negative pressure of the surge tank differs at the time of a full cylinder operation and a partial cylinder operation. Further, even if the change amount of the load is the same, the change amount of the negative pressure of the surge tank which is necessary differs at the time of the full cylinder operation and the partial cylinder operation. Considering that the negative pressure of the surge tank is closely related to the EGR amount, in order to keep the EGR rate at the time of a transitional operation correct irrespective of a full cylinder operation or a partial cylinder operation, it is considered as desirable to control the opening degree of the EGR valve by the method corresponding to the number of cylinders in operation.

### SUMMARY OF INVENTION

The present invention is made to solve the problem as described above, and has an object to provide a control device for an internal combustion engine which can keep an EGR rate at a transitional operation correct at the time of any of a full cylinder operation and a partial cylinder operation.

A control device according to the present invention is a control device that has an internal combustion engine as a control target, which includes a throttle in an intake passage upstream from a surge tank, includes an EGR valve in an EGR passage which connects the intake passage downstream from the throttle and an exhaust passage, and can switch a number of cylinders in operation between a total number of cylinders and some of the cylinders. The control device according to the present invention includes throttle operating means and an EGR valve operating means as means for controlling such an internal combustion engine. The throttle operating means operates the throttle to be at an opening degree corresponding to an accelerator operating amount and the number of cylinders in operation so that outputs with respect to the accelerator operating amount are equal at a time of a full cylinder operation and at a time of a partial cylinder operation. The EGR valve operating means operates the EGR valve to be at an opening degree corresponding to a throttle opening degree and the number of cylinders in operation so that an EGR rate becomes a target value. In more detail, the EGR valve operating means changes the opening degree of the EGR valve at a relatively high speed at the time of the full cylinder operation, and changes the opening degree of the EGR valve at a relatively low speed at the time of the partial cylinder operation, when the opening degree of the throttle is changed due to a change in the accelerator operating amount. The EGR valve operating means preferably changes the opening degree of the EGR valve at a speed corresponding to a change speed of a pressure in the surge tank.

At the time of the full cylinder operation and at the time of the partial cylinder operation, the air amounts per time for generating a constant output are substantially the same, but the pressure in the surge tank differs in accordance with the difference in the charging efficiency of air per cylinder, and the amount of air present in the surge tank also differs. When the accelerator operating amount is changed, the pressure in the surge tank is regulated by operation of the throttle so as to realize the change of the output corresponding to the change amount. At this time, the air amount required for changing the pressure in the surge tank through the throttle differs depending on the number of cylinders in operation. Specifically, the required air amount is smaller at the time of the full cylinder operation, and the required air amount is larger at the time of the partial cylinder operation. The passing speed at the time of air passing through the throttle is substantially constant, and therefore, if the air amount required for pressure change differs, the time required for pressure change also differs. More specifically, the time required for the pressure change is shorter at the time of the full cylinder operation, and the time required for the pressure change is longer at the time of the partial cylinder operation.

According to the control device according to the present invention, at the time of the full cylinder operation, the opening degree of the EGR valve is changed at a relatively high speed, and therefore, change of the opening degree of the EGR valve can be matched with the fast pressure change in the surge tank. Meanwhile, at the time of the partial cylinder operation, the opening degree of the EGR valve is changed at a relatively low speed, and therefore, change of the opening degree of the EGR valve can be matched with the slow pressure change in the surge tank. Like this, according to the control device according to the present invention, the opening degree of the EGR valve can be changed by being matched with the pressure change in the surge tank, and therefore, at the time of any of the full cylinder operation and the partial cylinder operation, the EGR rate at the time of a transitional operation can be kept correct.

Further, in another mode of the present invention, when the number of cylinders in operation is switched to the total number of cylinders from some of the cylinders, the throttle is closed to be at an opening degree corresponding to a full cylinder operation after or at a time point when the number of cylinders in operation is switched to the total number of cylinders, and the EGR valve is closed to be at an opening degree corresponding to the throttle opening degree at the time of the full cylinder operation before the throttle is closed to the opening degree corresponding to the full cylinder operation.

By performing a closing operation of the throttle and a closing operation of the EGR valve at such timings, the torque shortage can be prevented from occurring at the time of transition when the number of cylinders in operation is switched to the total number of cylinders from some of the cylinders, and the EGR rate can be prevented from being excessive.

In still another mode of the present invention, when the number of cylinders in operation is switched from the total number of cylinders to some of the cylinders, the throttle is opened to be at an opening degree corresponding to a partial cylinder operation before or at a time point when the number of cylinders in operation is switched to some of the cylinders, and the EGR valve is opened to be at an opening degree corresponding to the throttle opening degree at the time of the partial cylinder operation after the throttle is opened to the opening degree corresponding to the partial cylinder operation.

By performing an opening operation of the throttle and an opening operation of the EGR valve at such timings, the torque shortage can be prevented from occurring at the time of transition when the number of cylinders in operation is switched from the total number of cylinders to some of the cylinders, and the EGR rate can be prevented from being excessive.

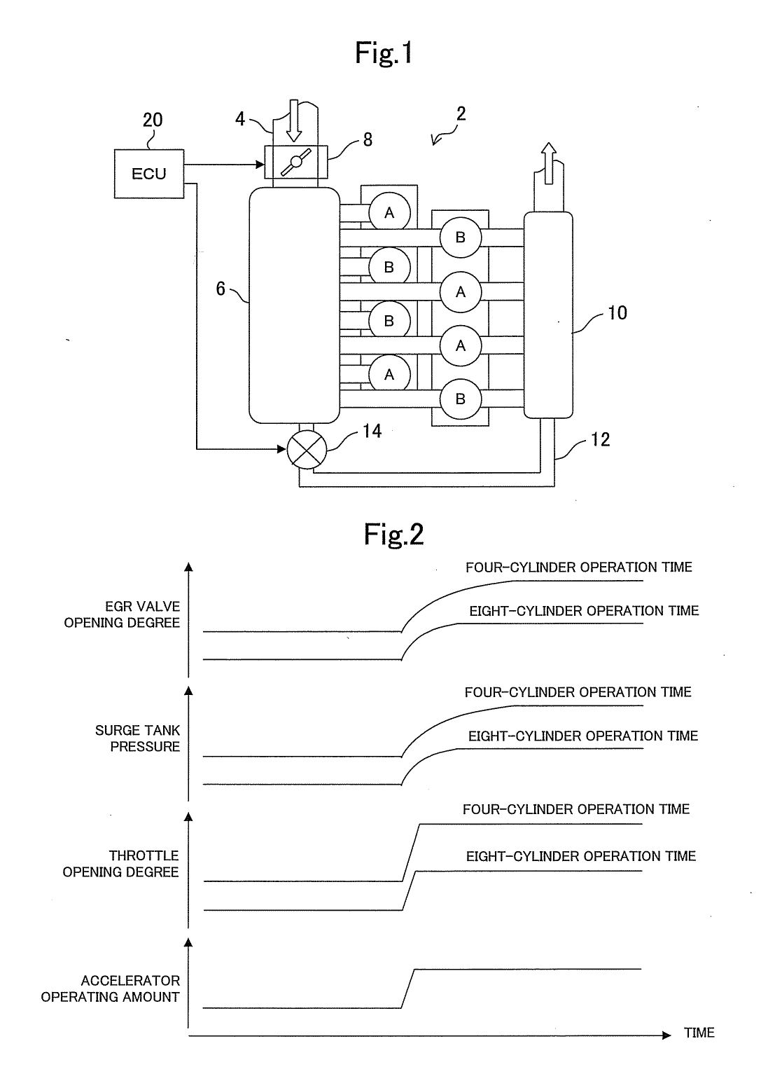

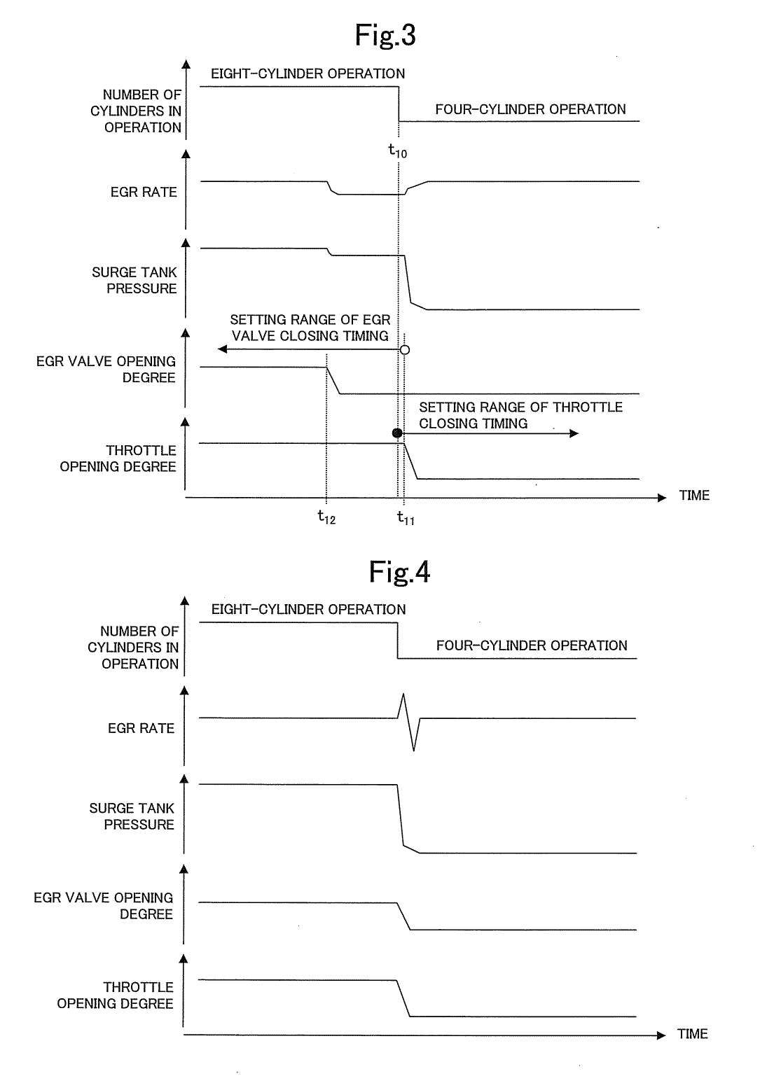

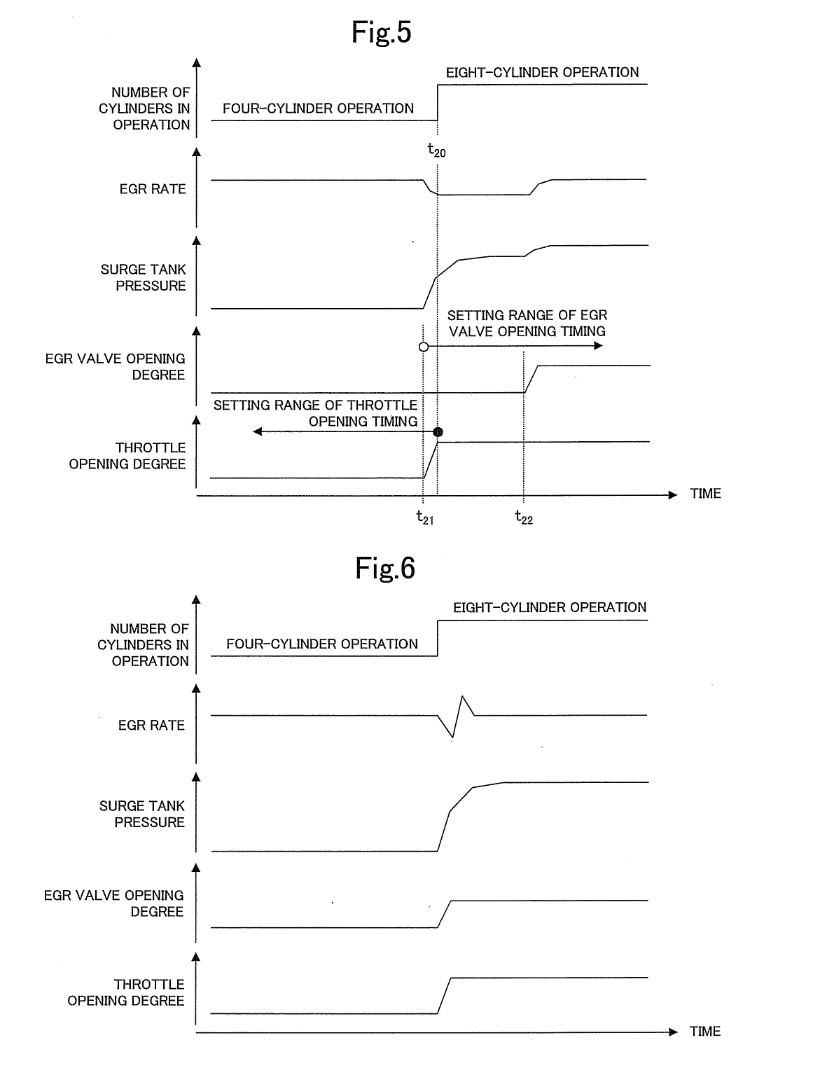

### BRIEF DESCRIPTION OF DRAWINGS

[FIG. 1] FIG. 1 is a view showing a schematic configuration of an internal combustion engine to which the present invention is applied.

[FIG. 2] FIG. 2 is a diagram for explaining setting of an operation speed of an EGR valve according to an embodiment of the present invention.

[FIG. 3] FIG. 3 is a timing chart showing a closing timing of a throttle and a closing timing of the EGR valve when the number of cylinders in operation is switched to the total number of cylinders from some of the cylinders.

[FIG. 4] FIG. 4 is a timing chart as a comparative example of FIG. 3.

[FIG. 5] FIG. 5 is a timing chart showing an opening timing of the throttle and an opening timing of the EGR valve when the number of cylinders in operation is switched from the total number of cylinders to some of the cylinders.

[FIG. 6] FIG. 6 is a timing chart as a comparative example of FIG. 5.

### DESCRIPTION OF EMBODIMENTS

An embodiment of the present invention will be described with reference to each of FIGS. 1 to 6.

FIG. 1 is a view showing a schematic configuration of an internal combustion engine to which a control device of an embodiment of the present invention is applied. An internal combustion engine 2 of the present embodiment is a V-type spark ignition four stroke engine having eight cylinders. The eight cylinders which the internal combustion engine 2 has are divided into groups A and B each with two cylinders at one bank. Four cylinders belonging to the group B include valve stop mechanisms not illustrated so as to be able to stop with intake valves and exhaust valves of the cylinders closed. When the intake valves and the exhaust valves are stopped, the cylinders are brought into an inactive state, and fuel supply to the cylinders is also stopped. More specifically, the internal combustion engine 2 of the present embodiment is a variable cylinder engine capable of switching the number of cylinders in operation between the total number of cylinders (eight cylinders) and some of the cylinders (four cylinders). In regard with the present invention, if at least the number of cylinders can be switched, the configuration and the workings of the valve stop mechanisms are not limited.

A surge tank 6 is formed in an intake passage 4 which supplies air to each of the cylinders. An electronic control type throttle 8 is provided in the intake passage upstream from the surge tank 6. Further, an EGR passage 12 connected to an exhaust passage 10 is connected to the surge tank 6. The EGR passage 12 is provided with an EGR valve 14. Operation of the throttle 8 and the EGR valve 14 is performed by an ECU (Electronic Control Unit) 20. The ECU 20 is a control device which generally controls the entire system of the internal combustion engine 2, and switch of the number of cylinders in operation is also performed by the ECU 20.

The ECU 20 carries out switch of the number of cylinders in operation by determining it from the vehicle speed and the load state of the internal combustion engine 2. Further, the ECU 20 switches a map for determining a throttle opening degree from the accelerator operating amount in accordance with the number of cylinders in operation. This is because depending on an eight-cylinder operation and a four-cylinder operation, a difference occurs to the output of the internal combustion engine 2 which can be realized at a constant throttle opening degree. The ECU 20 operates the throttle 8 to be at the opening degree corresponding to the accelerator operating amount and the number of cylinders in operation so that the outputs of the internal combustion engine 2 with respect to the accelerator operating amount become equal at the time of an eight-cylinder operation and at the time of a four-cylinder operation.

Further, the ECU 20 switches the map for determining the EGR valve opening degree from a load in accordance with the number of cylinders in operation. At the time of the eight-cylinder operation and the four-cylinder operation, air amounts (unit: g/s) per time for causing the internal combustion engine 2 to generate a constant output are substantially the same, but charging efficiencies of air per cylinder differ. For example, if the charging efficiency at the time of the eight-cylinder operation is 25%, the charging efficiency of about 50% is required at the time of the four-cylinder operation. A difference occurs in the pressure in the surge tank 6 in accordance with the difference in the charging efficiency, the EGR valve opening degrees which are required for achieving the same EGR rate differ at the time of the eight-cylinder operation and the four-cylinder operation. The ECU 20 operates the EGR valve 14 to the opening degree corresponding to the load and the number of cylinders in operation so that the EGR rate to the load becomes constant at the time of the eight-cylinder operation and at the time of the four-cylinder operation. The load is calculated from the throttle opening degree.

FIG. 2 is a diagram showing the relation of the accelerator operating amount and the throttle opening degree and the EGR valve opening degree for each of the time of the eight-cylinder operation and the time of the four-cylinder operation. As shown in FIG. 2, the throttle opening degree corresponding to the same accelerator operating amount is larger at the time of the four-cylinder operation than at the time of the eight-cylinder operation. Further, the EGR valve opening degree corresponding to the same accelerator operating amount is larger at the time of the four-cylinder operation than at the time of the eight-cylinder operation. Accordingly, the increase amount of the throttle opening degree when the accelerator operating amount increases, and the increase amount of the EGR valve opening degree are both larger at the time of the four-cylinder operation than at the time of the eight-cylinder operation.

When the accelerator operating amount increases, the ECU 20 changes the opening degree of the throttle 8 in accordance with the change amount of the accelerator operating amount, and changes the opening degree of the EGR valve 14 in accordance with the load change determined by the throttle opening degree. At this time, in regard with the throttle 8, the ECU 20 changes the throttle opening degree at a speed corresponding to the change speed of the accelerator operating amount irrespective of the number of cylinders in operation. Meanwhile, in regard with the EGR valve 14, the ECU 20 changes the EGR valve opening degree at a relatively high speed at the time of the eight-cylinder operation, and changes the EGR valve opening degree at a relatively low speed at the time of the four-cylinder operation.

The reason why the operation speed of the EGR valve 14 is made different in accordance with the number of cylinders in operation is as follows. When the accelerator operating amount is changed, the opening degree of the throttle 8 is changed to realize the change of the output corresponding to the change amount, and the pressure in the surge tank 6 is regulated. At this time, the air amount (unit: g) required for changing the pressure in the surge tank 6 through the throttle 8 differs depending on the number of cylinders in operation. The required air amount is smaller at the time of the eight-cylinder operation, and the required air amount is larger at the time of the four-cylinder operation. For example, if the increase amount of the air amount in the surge tank 6 which is required at the time of the eight-cylinder operation is 2 g, the increase amount of the air amount of about 4 g is required at the time of the four-cylinder operation. The passing speed at the time of air passing through the throttle 8 is substantially constant, and therefore, if the air amount required for pressure change differs, the time required for pressure change also differs. More specifically, the time required for the pressure change is shorter at the time of the eight-cylinder operation, and the time required for the pressure change is longer at the time of the four-cylinder operation. For example, if the change time of the pressure in the surge tank 6 which is required at the time of the eight-cylinder operation is 0.1 seconds, the change time of about 0.2 seconds is required at the time of the four-cylinder operation.

From the above, if the EGR valve 14 is opened at a relatively high speed at the time of the eight-cylinder operation, the change of the opening degree of the EGR valve 14 can be matched with the fast pressure increase in the surge tank 6. Conversely, if the EGR valve 14 is opened at a relatively low speed at the time of the four-cylinder operation, the change of the opening degree of the EGR valve 14 can be matched with the slow pressure increase in the surge tank 6. In this way, by changing the opening degree of the EGR valve 14 in accordance with the pressure increase in the surge tank 6, the EGR rate at the time of acceleration can be kept correct at the time of any of the eight-cylinder operation and the four-cylinder operation.

The determination concerning the above mentioned operation speed of the EGR valve 14 is also applied to the case in which the accelerator operating amount is decreased. More specifically, when the accelerator operating amount is decreased, the EGR valve 14 is closed at a relatively high speed at the time of the eight-cylinder operation, and the EGR valve 14 is closed at a relatively low speed at the time of the four-cylinder operation. By doing so, the opening degree of the EGR valve 14 can be changed to correspond to the pressure reduction in the surge tank 6, and the EGR rate at the time of deceleration can be kept correct at the time of any of the eight-cylinder operation and the four-cylinder operation.

Next, each of the operations of the throttle 8 and the EGR valve 14 at the time of switching the number of cylinders in operation will be described. When the number of cylinders in operation is switched while the output of the internal combustion engine 2 is kept constant, the pressure in the surge tank 6 is regulated by changing the opening degree of the throttle 8, and the EGR rate needs to be kept at a target value by changing the opening degree of the EGR valve 14. As each of the operation timings of the throttle 8 and the EGR valve 14 in that case, the timing simultaneous with switching of the number of cylinders in operation is conceivable as one idea, as shown in the respective timing charts of FIGS. 4 and 6.

In the example shown in the timing chart of FIG. 4, the throttle 8 is operated to the closing side in accordance with the switching timing to the eight-cylinder operation from the four-cylinder operation, and the EGR valve 14 is operated to the closing side in the same timing. Further, in the example shown in the timing chart of FIG. 6, the throttle 8 is operated to the opening side in accordance with the switching timing to the four-cylinder operation from the eight-cylinder operation, and the EGR valve 14 is operated to the opening side in the same timing. However, as is understood from the chart of the time change of the EGR rate shown in the respective drawings, when such timings are adopted, the EGR rate is likely to vary significantly as a result of the pressure balance being lost transitionally.

Special caution should be taken to an abrupt increase in the EGR rate among such variations of the EGR rate. When the EGR rate abruptly increases, combustion becomes unstable, and a misfire is likely to occur. A misfire causes a torque variation, generates a large amount of an unburned gas, and may further cause deterioration of the catalyst. Meanwhile, when the EGR rate abruptly decreases, a knock is likely to occur, but a knock can be dealt by another method, for example, angle retardation of the ignition timing.

Further, when the timing of switching the number of cylinders in operation and the operation timing of the throttle 8 are not well matched with each other, a torque variation is likely to occur. For example, if the surge tank pressure is reduced before switching to the eight-cylinder operation from the four-cylinder operation is completed, the output of the internal combustion engine 2 is transitionally reduced due to air shortage. Reduction in output cannot be compensated by the other means. Further, contrary to this, the output of the internal combustion engine 2 sometimes becomes excessively large due to excessive air. However, in that case, the output can be regulated by angle retardation of the ignition timing or the like.

As the above discussion, with regard to each of the operations of the throttle 8 and the EGR valve 14 at the time of switching the number of cylinders in operation, it is important how to prevent the variation of the EGR rate, in particular, abrupt increase in the EGR rate. Further, it is also important how to prevent output reduction of the internal combustion engine 2. Thus, in the present embodiment, at the time of switching the number of cylinders in operation, the operation of the throttle 8 and the operation of the EGR valve 14 are carried out in the following timing.

FIG. 3 is a timing chart showing the timing of the closing operation of the throttle 8 and the timing of the closing operation of the EGR valve 14 at the time of switching the number of cylinders in operation to eight cylinders from four cylinders. FIG. 3 shows a chart of each time change of the surge tank pressure and the EGR rate in combination. In FIG. 3, the timing at which the number of cylinders in operation is switched to eight cylinders from four cylinders is described as t₁₀, the timing at which the throttle 8 is closed to the opening degree corresponding to the eight-cylinder operation is described as t₁₁, and the timing at which the EGR valve 14 is closed to the opening degree corresponding to the throttle opening degree at the time of the eight-cylinder operation is described as t₁₂.

As shown in FIG. 3, the timing t₁₁ of the closing operation of the throttle 8 is set at the same timing as the timing t₁₀ of switching the number of cylinders in operation, or the timing after the switching timing. More specifically, the ECU 20 operates the throttle 8 to the closing side after completion of switching to the eight-cylinder operation from the four-cylinder operation. If the closing operation of the throttle 8 is performed at such a timing, shortage of the air amount does not occur at the time of switching the number of cylinders in operation, and the output reduction at the time of transition can be prevented.

The-timing t₁₂ of the closing operation of the EGR valve 14 is set at the timing before the timing t₁₁ of the closing operation of the throttle 8. More specifically, the ECU 20 operates the EGR valve 14 to the closing side, and thereafter, operates the throttle 8 to the closing side to decrease the surge tank pressure. According to such setting of the timing, decrease of the surge tank pressure before closure of the EGR valve 14 can be avoided, and therefore, the EGR rate is prevented from being excessive due to increase in the EGR amount. During the time until the throttle 8 is operated to the closing side after the EGR valve 14 is operated to the closing side, the EGR rate is in a lower state than the target value due to decrease in the EGR amount. In this case, a knock is likely to occur due to an insufficient EGR rate, but the knock can be suppressed by angle retardation of the ignition timing.

The sequential relation of the timing t₁₀ of switching the number of cylinders in operation and the timing t₁₂ of the closing operation of the EGR valve 14 is not limited. In FIG. 3, the closing operation of the EGR valve 14 is performed first, but the EGR valve 14 may be operated to the closing side after switching of the number of cylinders in operation is completed.

FIG. 5 is a timing chart showing the timing of the opening operation of the throttle 8 at the time of switching the number of cylinders in operation to four cylinders from eight cylinders, and the timing of the opening operation of the EGR valve 14. FIG. 5 shows a chart of each time change of the surge tank pressure and the EGR rate in combination. In FIG. 5, the timing at which the number of cylinders in operation is switched to four cylinders from eight cylinders is described as t₂₀, the timing at which the throttle 8 is opened to the opening degree corresponding to the four-cylinder operation is described as t₂₁, and the timing at which the EGR valve 14 is opened to the opening degree corresponding to the throttle opening degree at the time of the four-cylinder operation is described as t₂₂.

As shown in FIG. 5, the timing t₂₁ of the opening operation of the throttle 8 is set at the same timing as the timing t₂₀ of switching the number of cylinders in operation, or the timing before the switching timing. More specifically, the ECU 20 operates the throttle 8 to the opening side before completion of switching to the four-cylinder operation from the eight-cylinder operation. If the opening operation of the throttle 8 is performed at such a timing, shortage of the air amount does not occur at the time of switching the number of cylinders in operation, and output reduction at the time of transition can be prevented.

The timing t₂₂ of the opening operation of the EGR valve 14 is set at the timing after the timing t₂₁ of the opening operation of the throttle 8. More specifically, the ECU 20 increases the surge tank pressure by operating the throttle 8 to the opening side, and thereafter, operates the EGR valve 14 to the opening side. According to such setting of the timing, opening of the EGR valve 14 in the state in which the surge tank pressure is in a low state can be avoided. Therefore, the EGR rate is prevented from being excessive due to increase in the EGR amount. During the time until the EGR valve 14 is operated to the opening side after the throttle 8 is operated to the opening side, the EGR rate is in a lower state than the target value due to decrease in the EGR amount. In this case, a knock is likely to occur due to an insufficient EGR rate, but the knock can be suppressed by angle retardation of the ignition timing.

The sequential relation of the timing t₂₀ of switching the number of cylinders in operation and the timing t₂₂ of the opening operation of the EGR valve 14 is not limited. In FIG. 3, the opening operation of the EGR valve 14 is performed later, but the EGR valve 14 may be operated to the opening side before switching of the number of cylinders in operation is completed.

The embodiment of the present invention is described above, but the present invention is not limited to the aforementioned embodiment, and can be carried out by being variously modified in the range without departing from the gist of the present invention. For example, the present invention can also be applied to multiple-cylinder engines other than an eight-cylinder engine, for example, a six-cylinder engine and a four-cylinder engine.

### DESCRIPTION OF REFERENCE NUMERALS

2 Internal combustion engine
4 Intake passage
6 Surge tank
8 Throttle
10 Exhaust passage
12 EGR passage
14 EGR valve
20 ECU

1. A control device for an internal combustion engine which includes a throttle in an intake passage upstream from a surge tank, includes an EGR valve in an EGR passage which connects the intake passage downstream from the throttle and an exhaust passage, and can switch a number of cylinders in operation between a total number of cylinders and some of the cylinders, comprising:
throttle operating means which operates the throttle to be at an opening degree corresponding to an accelerator operating amount and the number of cylinders in operation so that outputs with respect to the accelerator operating amount become equal at a time of a full cylinder operation and at a time of a partial cylinder operation; and
EGR valve operating means which operates the EGR valve to be at an opening degree corresponding to an opening degree of the throttle and the number of cylinders in operation so that an EGR rate becomes a target value,
wherein the EGR valve operating means changes the opening degree of the EGR valve at a relatively high speed at the time of the full cylinder operation, and changes the opening degree of the EGR valve at a relatively low speed at the time of the partial cylinder operation, when the opening degree of the throttle is changed due to a change in the accelerator operating amount.

2. The control device for an internal combustion engine according to claim 1,
wherein the EGR valve operating means changes the opening degree of the EGR valve at a speed corresponding to a change speed of a pressure in the surge tank.

3. The control device for an internal combustion engine according to claim 1,
wherein when the number of cylinders in operation of the internal combustion engine is switched to the total number of cylinders from some of the cylinders,
the throttle operating means closes the throttle to be at an opening degree corresponding to the full cylinder operation after or at a time point when the number of cylinders in operation is switched to the total number of cylinders, and
the EGR valve operating means closes the EGR valve to be at an opening degree corresponding to the throttle opening degree at the time of the full cylinder operation before the throttle is closed to the opening degree corresponding to the full cylinder operation.

4. The control device for an internal combustion engine according to claim 1,
wherein when the number of cylinders in operation of the internal combustion engine is switched from the total number of cylinders to some of the cylinders,
the throttle operating means opens the throttle to be at an opening degree corresponding to the partial cylinder operation before or at a time point when the number of cylinders in operation is switched to some of the cylinders, and
the EGR valve operating means opens the EGR valve to be at an opening degree corresponding to the throttle opening degree at the time of the partial cylinder operation after the throttle is opened to the opening degree corresponding to the partial cylinder operation.

5. The control device for an internal combustion engine according to claim 2,
wherein when the number of cylinders in operation of the internal combustion engine is switched to the total number of cylinders from some of the cylinders,
the throttle operating means closes the throttle to be at an opening degree corresponding to the full cylinder operation after or at a time point when the number of cylinders in operation is switched to the total number of cylinders, and
the EGR valve operating means closes the EGR valve to be at an opening degree corresponding to the throttle opening degree at the time of the full cylinder operation before the throttle is closed to the opening degree corresponding to the full cylinder operation.

6. The control device for an internal combustion engine according to claim 2,
wherein when the number of cylinders in operation of the internal combustion engine is switched from the total number of cylinders to some of the cylinders,
the throttle operating means opens the throttle to be at an opening degree corresponding to the partial cylinder operation before or at a time point when the number of cylinders in operation is switched to some of the cylinders, and
the EGR valve operating means opens the EGR valve to be at an opening degree corresponding to the throttle opening degree at the time of the partial cylinder operation after the throttle is opened to the opening degree corresponding to the partial cylinder operation.

7. The control device for an internal combustion engine according to claim 3,
wherein when the number of cylinders in operation of the internal combustion engine is switched from the total number of cylinders to some of the cylinders,
the throttle operating means opens the throttle to be at an opening degree corresponding to the partial cylinder operation before or at a time point when the number of cylinders in operation is switched to some of the cylinders, and
the EGR valve operating means opens the EGR valve to be at an opening degree corresponding to the throttle opening degree at the time of the partial cylinder operation after the throttle is opened to the opening degree corresponding to the partial cylinder operation.

8. A control device for an internal combustion engine which includes a throttle in an intake passage upstream from a surge tank, includes an EGR valve in an EGR passage which connects the intake passage downstream from the throttle and an exhaust passage, and can switch a number of cylinders in operation between a total number of cylinders and some of the cylinders, comprising:
a throttle operating device which operates the throttle to be at an opening degree corresponding to an accelerator operating amount and the number of cylinders in operation so that outputs with respect to the accelerator operating amount become equal at a time of a full cylinder operation and at a time of a partial cylinder operation; and
an EGR valve operating device which operates the EGR valve to be at an opening degree corresponding to an opening degree of the throttle and the number of cylinders in operation so that an EGR rate becomes a target value,
wherein the EGR valve operating device changes the opening degree of the EGR valve at a relatively high speed at the time of the full cylinder operation, and changes the opening degree of the EGR valve at a relatively low speed at the time of the partial cylinder operation, when the opening degree of the throttle is changed due to a change in the accelerator operating amount.
